(19) United States
(12) Patent Application Publication
(10) Pub. No.: US 2025/0378314 A1
(43) Pub. Date: Dec. 11, 2025

(54) CALIBRATION OF SPIKING NEURAL NETWORKS

(71) Applicant: INNATERA NANOSYSTEMS B.V., Rijswijk (NL)

(72) Inventors: Robin Felix KEAREY, Delft (NL); Aditya DALAKOTI, Voorburg (NL); Bart Leonard HETTEMA, Delft (NL); Amir ZJAJO, The Hague (NL)

(21) Appl. No.: 18/877,285

(22) PCT Filed: Jun. 28, 2023
(86) PCT No.: PCT/EP2023/067666

§ 371 Date: Dec. 20, 2024

Related U.S. Application Data
(60) Provisional application No. 63/356,559, filed on Jun. 29, 2022.

(51) Int. Cl. G06N 3/049

(52) U.S. Cl. CPC G06N 3/049

(57) ABSTRACT

A spiking neural network comprising a plurality of input processing circuits, each input processing circuit having an input for receiving a spiking neural network input signal and being configured to apply a transfer function to the input signal to generate a processed input signal; a plurality of offset current generators, each offset current generator configured to generate an offset current signal at a predetermined level; a plurality of synapses, each synapse connected to receive a processed input signal from one of the input processing circuits and configured to apply a predetermined weight to the processed input signal to generate a synapse output signal; a plurality of neurons, each neuron connected to receive synapse output signals from a subset of the synapses and an offset current signal from one of the offset current generators, and each neuron configured to generate a neuron output signal in response to the received synapse output signals and offset current signal; and an analog-to-digital converter having an input, the input being connectable to receive an offset current signal from one of the offset current generators, and being configured to convert the received offset current signal to a corresponding digital output signal.

### TECHNICAL FIELD

This disclosure generally relates to automatic signal recognition techniques and spiking neural networks, and more particularly to systems and methods for calibration of spiking neural networks.

### BACKGROUND

Spiking neural networks (SNNs) are signal processing systems whose design is inspired by biological neural networks. Information is encoded in patterns of spike signals distributed across a network of neurons and synapses, as described in WO2022/090542A1 filed by the present applicant. By mimicking the processes occurring in biological brains, spiking neural networks can perform signal processing tasks that are typically performed by human brains. Examples include image recognition, sound recognition and detection of events based on input from multiple sensors.

The functionality of an SNN is determined by its network configuration and its weight matrix. The network configuration specifies how many neurons and synapses are used and how they are connected to each other and the input and output signals. It also defines what kind of pre and post processing circuits are needed as well as the complete connectivity between them. The weight matrix is a set of parameters that determine the parameters of each network element. Typically, this includes a gain factor for each synapse, but other parameters, such as neuron thresholds, could be included as well.

The network configuration is determined by the user, who chooses the network topology based on the intended application. The weight matrix, on the other hand, is generated from a training step, in which the SNN is exposed to a large amount of training data and its weights are automatically updated to bring the network's output close to the desired value.

Since the training step typically requires a long time to complete, it is preferably only performed once even if multiple copies of the SNN are manufactured. The weight matrix resulting from the training step is then copied into each individual piece of hardware. However, if the hardware that runs the SNN is different from the hardware that the network was trained on, the resulting network will perform differently and may fail to perform its intended function.

Analog and mixed signal circuits, typically fabricated as an integrated circuit, are a power-efficient way to implement SNNs. One drawback of analog signal processing circuits is that their performance can vary with manufacturing tolerances as well as environmental factors like temperature and supply voltage variations. Digitally assisted analog-mixed signal circuits can be used as an alternative to provide reliable performance. The amount of assistance needs to be bounded and optimized.

In order to provide reliable computation performance, these implementations of SNNs therefore need to be calibrated to ensure their performance is determined by their design, regardless of manufacturing variations or changes in operating conditions such as voltage and temperature. A calibration process aims to adjust the behaviour of analog circuits in the SNN to bring its performance in line with a predefined specification.

One method to ensure identical performance within acceptable bounds among different copies of an analog or mixed signal SNN is to train each single copy on the same set of training data. Each copy will then have its own weight matrix optimized to its unique hardware properties. Although this method will compensate for manufacturing errors, it does not reduce the circuits' variability as a result of temperature or voltage variations. Another drawback is that performing the training step for each individual copy can be time-consuming and costly.

Another method, described in WO2020/260067A1, performs a reduced training step on each individual copy of the SNN with the aim of adjusting the weights to the SNN's particular properties. This could still take a long time however, and is not guaranteed to converge to a working solution. Furthermore, it does not give any insight into the type and amount of variation in the internal components, making it difficult to improve the hardware design.

A faster and more robust calibration procedure is therefore needed which provides the possibility to adjust individual elements of the SNN, rather than adjust the entire SNN as a unit.

### SUMMARY OF INVENTION

To perform such an improved calibration procedure, circuit parameters may be measured and subsequently adjusted to conform to predefined specifications. In complex analog and mixed signal networks it may not be practical to directly measure all relevant parameters with sufficient accuracy, necessitating a calibration strategy that makes optimal use of observable parameters to deduce values for non-observable parameters. Relevant circuit parameters should be made adjustable with sufficient range to overcome expected variability and sufficient resolution to achieve the predefined specifications.

Due to the complexity of the SNN and the varied kind of components used in the design of an analog or mixed signal SNN system-on-a-chip (SoC), the optimal trade-off between performance versus the amount of calibration under the SoC constraints is a non-trivial problem. This invention provides a system and method for such calibration in an SNN with varied components, connectivity and limited observability and measurability.

In a first aspect, the invention comprises a spiking neural network (SNN). The SNN comprises a plurality of input processing circuits, each input processing circuit having an input for receiving a spiking neural network input signal and being configured to apply a transfer function to the input signal to generate a processed input signal; a plurality of offset current generators, each offset current generator configured to generate an offset current signal at a predetermined level; a plurality of synapses, each synapse connected to receive a processed input signal from one of the input processing circuits and configured to apply a predetermined weight to the processed input signal to generate a synapse output signal; a plurality of neurons, each neuron connected to receive synapse output signals from a subset of the synapses and an offset current signal from one of the offset current generators, and each neuron configured to generate a neuron output signal in response to the received synapse output signals and offset current signal; and an analog-to-digital converter having an input, the input being connectable to receive an offset current signal from one of the offset current generators, and being configured to convert the received offset current signal to a corresponding digital output signal.

The input processing circuits may include input shaping circuits, encoder circuits, signal conditioning circuits, filter circuits, and other types of circuits for processing the spiking neural network input signals. The input signals may comprise raw or pre-processed signals from sensors or other input devices, or may comprise the outputs from preceding spiking neural networks, signal processors, or other types of circuits.

The offset current generators preferably each comprise a direct current (DC) current source for providing a stable current at a predetermined current level that may be adjusted. The offset current generators may be used to provide a bias current to the neurons during operation of the spiking neural network.

The synapses are preferably arranged in an array, for example with a first subset of the synapses (e.g. a row of synapses) connected to receive a processed input signal from one of the input processing circuits, and a second subset of the synapses (e.g. a column of synapses) connected to provide their synapse output signals to one of the neurons. The array of synapses may be implemented as a crossbar array.

The spiking neural network may be implemented as an analog signal processing circuit or a mixed signal circuit combining analog and digital signal processing. The offset current generators, synapses, and neurons are implemented as hardware elements (e.g. hardware or hardware with software or firmware), preferably implemented in a single integrated circuit (IC), and may be implemented as an SoC. The input processing circuits may also be implemented in the same IC or SoC with the offset current generators, synapses, and neurons, or may be implemented as one or more external components.

The analog-to-digital converter may also be implemented in the same IC or SoC with the other components, or may be implemented as one or more external components. A single analog-to-digital converter may be included (reducing chip size and cost), or multiple analog-to-digital converters may be used (to provide a faster calibration process).

The offset current generators are preferably each individually adjustable to adjust the offset current signal. The spiking neural network may further comprise a first processing circuit connected or connectable to receive the digital output signal generated by the analog-to-digital converter, and configured to generate an adjustment signal for adjusting a corresponding one of the offset current generators to produce an adjusted offset current signal.

This adjustment preferably corrects for variation in each offset current generator, and may also correct for leakage current through the synapses which are connected to receive the offset current signal from the relevant offset current generator. Furthermore, this calibration of the offset current generators removes or reduces any variability introduced by the offset current generators and enables more accurate calibration of the other components of the spiking neural network. The first processing circuit may be implemented as a hardware circuit or a processor with software or firmware, and may be implemented in the same IC or SoC as the other components of the SNN or as a separate component which may be connected either permanently or during calibration.

The spiking neural network may further comprise a frequency measurement circuit connected to receive a neuron output signal from one of the neurons, and generate an output indicating a frequency of the received neuron output signal. The frequency measurement circuit may be implemented using a reference clock signal and components included on the same IC or SoC which contains the synapses and neurons.

The neurons of the spiking neural network may be individually adjustable to adjust an input gain, a spike threshold, and/or a reference potential offset value of the neuron. The spiking neural network may further comprise a second processing circuit connected or connectable to receive the output from the frequency measurement circuit, and configured to generate an adjustment signal for adjusting a corresponding one of the neurons.

The neurons are connected to receive the offset currents from the offset current generators, and preferably the offset current generators have been calibrated previously so that they generate the adjusted offset currents having known predetermined values. Since the input to each neuron is known and the frequency of the spikes produced by the neuron is measured, the transfer function of the neuron may be calculated to generate an adjustment signal to correct for variation in the neuron. The second processing circuit may be implemented using the same processor as the first processing circuit.

Each of the synapses of the SNN may be adjustable to adjust an input gain and/or an offset value of the synapse. Each of the input processing circuits may be adjustable to adjust an input gain, a spike threshold, and/or a timing value of the input processing circuit.

The analog-to-digital converter is preferably connectable to receive a synapse output signal from one of the synapses, and is configured to convert the received synapse output signal to a corresponding digital synapse output signal. For example, the analog-to-digital converter may have a hardwired connection or a switched connection for receiving the synapse output signals.

The SNN may be further configured to provide a calibration mode in which one or more of the spiking neural network input signals are set to predetermined values. The input signals may comprise a train of spikes having a predetermined frequency and/or magnitude, or a constant input current or voltage having a predetermined value, or some other signal. Applying a known input signal enables the transfer function of various components of the spiking neural network to be determined to assist with calibration.

The SNN may further comprise a third processing circuit connected or connectable to receive a signal from the frequency measurement circuit indicating a frequency of a neuron output signal of one of the neurons during the calibration mode, the neuron connected to receive a synapse output signal from one of the synapses which is connected to receive a processed input signal from one of the input processing circuits, wherein the third processing circuit is configured to generate an adjustment signal for adjusting the input processing circuit and/or the synapse.

Since the input to the input processing circuit is known, and the frequency of the spikes produced by the neuron is measured, the transfer function of the combination of the input processing circuit and the synapse (which sends a synapse output signal to the neuron) may be calculated to generate an adjustment signal. This adjustment signal may be used to correct for variation in the input processing circuit and/or the synapse. The third processing circuit may be implemented using the same processor as the first and/or second processing circuits.

The analog-to-digital converter of the SNN may be connectable to receive a synapse output signal from one of the synapses and may be configured to convert the received synapse output signal to a corresponding digital synapse output signal. The SNN may further comprise a fourth processing circuit connected or connectable to receive the digital synapse output signal during the calibration mode, and configured to generate an adjustment signal for adjusting the input processing circuit and/or the synapse.

Since the input to the input processing circuit is known, and the output of the synapse is measured, the transfer function of the combination of the input processing circuit and the synapse (which sends a synapse output signal to the neuron) may be calculated to generate an adjustment signal. This adjustment signal may be used to correct for variation in the input processing circuit and/or the synapse. The fourth processing circuit may be implemented using the same processor as the first, second and/or third processing circuits.

In a second aspect, the invention provides a method for calibrating a spiking neural network, the spiking neural network comprising a plurality of offset current generators configured to generate offset current signals, a plurality of input processing circuits configured to generate processed input signals, a plurality of synapses configured to apply a weight to the processed input signals to generate synapse output signals, and a plurality of neurons connected to receive one of the offset current signals and synapse output signals from a plurality of the synapses and configured to generate neuron output signals. The method comprises: generating a plurality of offset current signals, each at a predetermined level, by the plurality of offset current generators; converting the offset current signals to corresponding digital output signals; and adjusting the offset current generators based on the digital output signals to produce an adjusted offset current signal from each of the offset current generators.

The calibration method may be used in the SNN according to the first aspect of the invention as described herein, and details of the SNN described herein may also be applicable for the calibration methods. The calibration method comprises measuring the output of each offset current generator, converting this to a digital signal, and using the resulting digital signal to adjust each offset current generator. This procedure can be used to correct for variation in each offset current generator, and may also correct for leakage current through the synapses which are connected to receive the offset current signal from the relevant offset current generator. This calibration of the offset current generators removes or reduces any variability introduced by the offset current generators and enables more accurate calibration of the other components of the spiking neural network.

The calibration method may further comprise: receiving the plurality of adjusted offset current signals in the plurality of neurons; measuring a frequency of the neuron output signals; and adjusting an input gain, a spike threshold, and/or a reference potential offset value of each of the neurons based on the adjusted offset current signal received by the respective neuron and the measured frequency of the neuron output signal generated by the respective neuron. The method may further comprise calculating a transfer function for the neurons, wherein the transfer function for each neuron is based on the adjusted offset current signal received by the neuron and the measured frequency of the neuron output signal of the neuron.

The calibration of the neurons makes use of the adjusted offset currents from the offset current generators, preferably previously calibrated to provide the offset currents having known predetermined values. Since this input to each neuron is known and the frequency of the spikes produced by the neuron is measured, the transfer function of the neuron may be calculated and an adjustment signal may be generated to correct for variation in each neuron.

The calibration method may further comprise: providing a spiking neural network input signal set to a predetermined value to a first one of the input processing circuits; setting a weight of a first one of the synapses to a predetermined value; receiving a processed input signal from the first input processing circuit by the first synapse, and generating a corresponding synapse output signal in response; receiving the synapse output signal from the first synapse and an adjusted offset current signals from a first one of the offset current generators by a first one of the neurons; measuring a frequency of the neuron output signal generated by the first neuron; and adjusting the first input processing circuit and/or adjusting the first synapse to adjust a transfer function of the first input processing circuit and the first synapse based on the spiking neural network input signal and the measured neuron output signal frequency.

The input signals may comprise a train of spikes having a predetermined frequency and/or magnitude, or a constant input current or voltage having a predetermined value, or some other predetermined signal. Since the input to the input processing circuit is known, and the frequency of the spikes produced by the neuron is measured, the transfer function of the combination of the input processing circuit and the synapse may be calculated to generate an adjustment signal. This adjustment signal may be used to correct for variation in the input processing circuit and/or the synapse.

The effects of variation in the input processing circuit and in the synapse can be separated to a certain extent by performing the calibration method on a subset (e.g. a row) of the synapses. This calibration method comprises: providing a spiking neural network input signal set to a predetermined value to a first one of the input processing circuits; setting weights of a first subset of the synapses to predetermined values; receiving a processed input signal from the first input processing circuit by the first subset of synapses, and generating a corresponding synapse output signal from each synapse of the first subset of synapses in response; receiving the synapse output signals from the first subset of synapses by the neurons; measuring a frequency of each neuron output signal generated by the neurons; and adjusting the first input processing circuit to adjust a transfer function of the first input processing circuit based on the measured frequencies of the neuron output signals.

This embodiment of the calibration method enables the effect of variation in the input processing circuit and in the synapse to be separated to a certain extent. The synapse output signals from a first subset of the synapses (e.g. from a row of synapses in a crossbar array which all receive the same processed input signal) may be averaged to average out the variations in the synapses, leaving substantially only the variation for the input processing circuit. An adjustment signal may then be calculated to adjust the input processing circuit to account for the variation.

Once the transfer function of the input processing circuit has been determined, and the input processing circuit adjusted if possible to account for variation in the circuit, a further calibration procedure can be performed to calibrate the individual synapses. This calibration comprises: providing a spiking neural network input signal set to a predetermined value to a first one of the input processing circuits; receiving a processed input signal from the first input processing circuit by a first one of the first subset of synapses, and generating a corresponding synapse output signal in response; receiving the synapse output signal from the first synapse and an adjusted offset current signal from a first one of the offset current generators by a first one of the neurons; measuring a frequency of the neuron output signal generated by the first neuron; and adjusting the first synapse to adjust a transfer function of the first synapse based on the spiking neural network input signal and the measured neuron output signal frequency.

The calibration methods may use measurements of neuron output frequency, which may provide an indication of the synapse output current received by the neuron when the transfer function of the neuron is known. An alternative is to directly measure the synapse output signal. Thus, the calibration method may comprise: providing a spiking neural network input signal set to a predetermined value to a first one of the input processing circuits; setting a weight of a first one of the synapses to a predetermined value; receiving a processed input signal from the first input processing circuit by the first synapse, and generating a corresponding synapse output signal in response; converting the synapse output signal to a corresponding digital output signal; and adjusting the first input processing circuit and/or adjusting the first synapse to adjust a transfer function of the first input processing circuit and the first synapse based on the spiking neural network input signal and the digital output signal. This variation in the calibration method uses an analog-to-digital converter to measure the output signal of the synapse, rather than sending the synapse output signal to a neuron and measuring the output of the neuron.

Similarly, the effect of variation in the input processing circuit and in the synapse to be separated in a calibration method comprising: providing a spiking neural network input signal set to a predetermined value to a first one of the input processing circuits; setting weights of a first subset of the synapses to predetermined values; receiving a processed input signal from the first input processing circuit by the first subset of synapses, and generating a corresponding synapse output signal from each synapse of the first subset of synapses in response; converting the synapse output signals from the first subset of synapses to corresponding digital output signals; and adjusting the first input processing circuit to adjust a transfer function of the first input processing circuit based on the spiking neural network input signal and the digital output signals.

Similarly, the synapses may be calibrated in a calibration method further comprising: providing a spiking neural network input signal set to a predetermined value to a first one of the input processing circuits; receiving a processed input signal from the first input processing circuit by a first one of the first subset of synapses, and generating a corresponding synapse output signal in response; converting the synapse output signal from the first synapse to a corresponding digital output signal; and adjusting the first synapse to adjust a transfer function of the first synapse based on the spiking neural network input signal and the digital output signal.

A single calibration round may be performed for each individual SNN (e.g. each IC or SoC) to compensate for manufacturing tolerances. Further calibration rounds can also be performed during the SNN's operation to counteract changes in temperature and supply voltage.

### BRIEF DESCRIPTION OF THE DRAWINGS

Embodiments will now be described, by way of example only, with reference to the accompanying drawings in which corresponding reference symbols indicate corresponding parts, and in which:

FIG. 1 is a conceptual diagram of a minimal spiking neural network (SNN);

FIG. 2 is a simplified schematic diagram of an SNN implemented as a crossbar array;

FIG. 3A is a simplified schematic diagram of an input shaping circuit which may be used as an input processing circuit in the SNN of FIG. 2 and FIG. 6;

FIG. 3B is a diagram showing an input signal to the input shaping circuit of FIG. 3A;

FIG. 3C is a diagram showing a spike output signal generated by the input shaping circuit of FIG. 3A;

FIG. 4 is a simplified schematic diagram of a synapse which may be used in the SNN of FIG. 2 and FIG. 6;

FIG. 5 is a simplified schematic diagram of a neuron which may be used in the SNN of FIG. 2 and FIG. 6;

FIG. 6 is a simplified schematic diagram of the SNN of FIG. 2 also including offset current generators and an analog-to-digital converter;

FIG. 7 is a simplified schematic diagram of an offset current generator which may be used in the SNN of FIG. 6;

FIG. 8 is a simplified schematic diagram of an overall structure of an SNN with associated analog-to-digital convertor, processor and memory;

FIG. 9 is a flowchart showing steps of calibration procedure for an analog-to-digital convertor;

FIG. 10 is a flowchart showing stages of a calibration procedure;

FIG. 11 is a flowchart of a calibration procedure for the offset current generators of the SNN of FIG. 6 or FIG. 8;

FIG. 12 is a flowchart of a calibration procedure for the neurons of the SNN of FIG. 6 or FIG. 8; and

FIG. 13 is a flowchart of a calibration procedure for the input processing circuits and synapses of the SNN of FIG. 6 or FIG. 8.

### DESCRIPTION OF EMBODIMENTS

Hereinafter, certain embodiments will be described in further detail. It should be appreciated, however, that these embodiments should not be construed as limiting the scope of protection for the present disclosure.

An artificial SNN is an electronic system that mimics the signal-processing functionality of the brain. It is built up from components that implement the same network structures as found in biological brains and processes information in a similar way. SNNs are especially suited to tasks like audio or video recognition, pattern spotting in large datasets or monitoring of sensor data for anomalies.

Compared to traditional digital electronic systems, SNNs can perform signal processing tasks at significantly lower power and with lower latency. Low power consumption is achieved because only those parts of the system are active that are actually processing data at any one time. The inherently parallel architecture of SNNs ensures low latency from input to output. Both properties are important for always-on signal processing applications in power-constrained environments, such as keyword spotting in battery-powered devices like smart watches.

Like their biological counterparts, SNNs use spike trains as their internal signal representation. Information is encoded in one or more features of these spike trains, such as frequency, phase, spike width, spike density and amplitude. As these spike trains travel along a network, they undergo basic mathematical operations like addition, multiplication and integration. These operations, together with the topology of the network, implement a specific signal processing function.

The exact parameters of all internal components are not set directly by the user, but are derived through a learning process. During this process, the network is exposed to a range of plausible input signals and the output observed, while the internal parameters are tuned until the output becomes close to the expected value. In this way, the internal parameters will converge to a set of values that enable the network to perform the desired signal processing functionality.

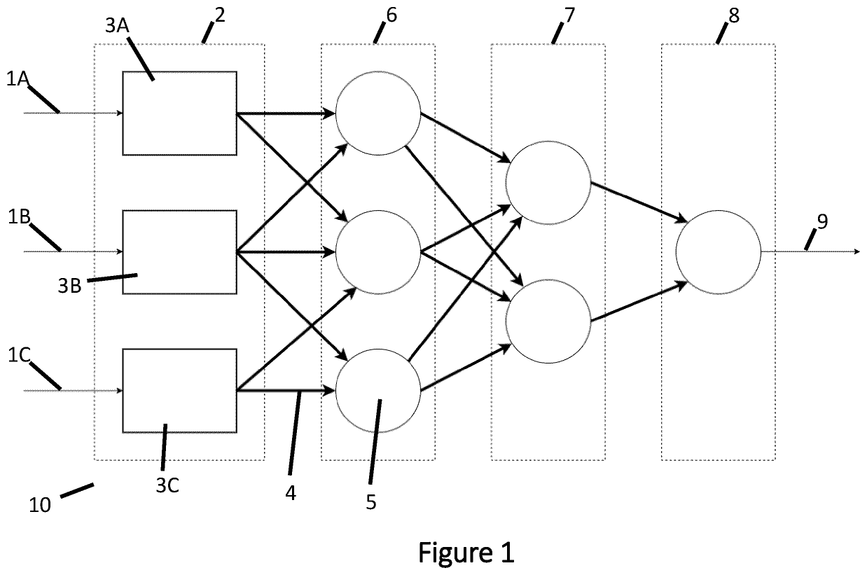

FIG. 1 is a conceptual diagram of a simple spiking neural network (SNN). This SNN comprises an input layer 2 of input processing circuits 3, connected to multiple layers of neurons and synapses in neurosynaptic layers 6, 7, 8. One such neurosynaptic layer consists of a set of synapses 4 whose input ports are connected to the previous layer and whose outputs are connected to a set of neurons 5. The output 9 of the overall system is generated by the last layer of neurons in the network. The output 9 of the last layer is then passed to a decoding layer which can pass the information forward to the end user in a meaningful format.

The input layer 2 receives SNN inputs 1A, 1B, 1C which undergo processing by the input processing circuits 3A, 3B, 3C. The processed input signals are then provided to neurosynaptic layers 6, 7, 8, each comprising neurons 5 connected via synaptic connections 4, resulting in output signal 9 generated by the last neurosynaptic layer. Each one of these layers may have a digital, analog or a mixed signal implementation as described further below.

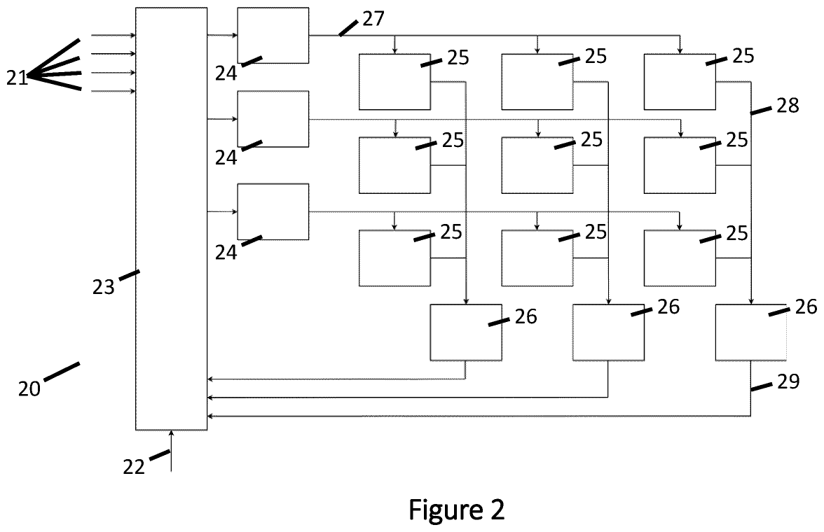

FIG. 2 is a simplified schematic diagram of an SNN 20 implemented as a crossbar array. A crossbar design is an efficient way of implementing a reconfigurable SNN system, especially when manufactured on an integrated circuit. This comprises a rectangular array of synapses with input processing circuits on one side of the array and neurons on another side. In the embodiment in FIG. 2, input processing circuits 24 are arranged in one column, each driving a row of synapses 25. The synapses 25 are connected in columns, with the outputs of all synapses 25 in a column added together and serving as the input to a neuron 26. By programming appropriate weights in the synapse array and correctly configuring the interconnect system, a wide variety of network topologies can be implemented.

The signals to be processed (e.g. from a sensor) are typically first pre-processed by an encoder to convert a sensor output signal into a suitable digital or analog signal, and the input signal processing may also include filters in both time and amplitude domain, and different kinds of input shaping circuits to generate a signal suitable for input to the computational layers of the network. All or some of this input processing may be performed in the input processing circuits 24 or may be performed in whole or in part by an input layer separate from the SNN shown in FIG. 2.

In FIG. 2, the input processing circuits 24 receive inputs 21 to the SNN via an interconnect 23, which may be used to interconnect several SNN arrays such as shown in FIG. 2. Each input processing circuit 24 generates a processed input signal 27 which is received by a row of synapses 25 in the neurosynaptic array.

The function of the input processing circuits 24 (e.g. including input shaping circuits and filtering circuits) is to modify incoming signals 21 in such a way that they can be processed by the neural network. Incoming signals 21 can have their information encoded in amplitude, frequency, phase or any other analog or digital modulation scheme and need to be processed to extract useful information to be further processed by the neural network. The input processing circuits 24 will typically contain filters, comparators, demodulators and other signal-processing circuits at their input and a spike-generating circuit on their output. The frequency, amplitude, shape and other parameters of the output spikes are modified to encode the information that was present in the input signal 21.

The synapses 25 amplify or attenuate incoming signals 27 by a constant factor determined by their weight setting. The weight for each synapse 25 is stored in a memory cell associated with the synapse. The values of all the weights in the network is known as the weight matrix and contains the information that was extracted from the input data during the learning process.

In the embodiment in FIG. 2, a row of synapses 25 receive a processed input signal 27 from one input processing circuit 24. Each synapse 25 applies a weight to the received processed input signal 27 and generates a synapse output signal 28.

The synapse output signals 28 from a column of synapses 25 is received by a neuron 26. Each neuron 26 integrates the received synapse output signals 28 and generates a neuron output signal 29 when the integrated value reaches a predetermined threshold, so that the neuron output signal 29 takes the form of a spike train. The neuron output signal 29 depends on several parameters of the neuron, such as the input gain, integration constant and threshold values.

The neurons output signals 29 are provided to the interconnect 23 and may be provided to a decoder. The decoder interprets the computation done by multiple neurons since the final answer may be encoded in time or phase and needs to be decoded. These can be time measurement circuits or phase detection circuits.

It will be understood that a practical implementation of an SNN typically comprises a very large number of neurons, e.g. hundreds of thousands or millions of neurons, and a correspondingly large number of synapses and input processing circuits. A large SNN may be divided into a number of smaller SNNs with signals being communicated among the smaller SNNs, e.g. using an interconnect 23 as shown in the embodiment of FIG. 2. The interconnect 23 may be configurable via a configuration input 22.

Depending on the use case being handled by the SNN, there are different connectivities for the design which are possible. For example, a high-level connectivity may be: Input, Encoder, Input processing circuit 24, Synapses 25, Neurons 26, Decoder, Output. Additional connectivities are possible within the high level connectivities, such as feedback connections from each stage to the other stage, feedforward connections from each stage to the other stage, different connectivity structures such as a crossbar, and different input and output reference points from different connectivities of each stage. The complex connectivities at the SoC level for SNN are use case driven. These complex connectivities create a scenario that maintaining consistent and predictable operations in view of the device variations is a challenge.

### SNN Implementations

An SNN can be implemented as a software model running on a processor, or the elements of the SNN (e.g. the synapses and neurons) may be fabricated as hardware elements (although the SNN may also make use of some software for some functionality). A hardware implementation can be realized using digital or analog circuits, and built from discrete components or manufactured as an integrated circuit. Full digital implementations of SNN implement the functions of a neural network using digital functions which are synthesized. The designs can be made more complex at a trade-off of increased chip area and higher operating power, the increase in chip area and power usually being directly proportional to complexity of the core logic.

Analog and mixed signal implementations on the other hand can potentially be very efficient in power and chip area because the two mathematical operations performed by the synapses and neurons, that is multiplication and integration respectively, can be efficiently implemented using analog circuits. Increased circuit complexity does not require a heavy trade-off with chip area and operating power. These analog implementations have a larger design space than digital, since analog circuits can make use of information encoded in both the phase and amplitude of input signals, in addition to signal timing which digital implementations can use. The increased design space results in chip area and operating power not scaling proportionally to the complexity of analog designs. However, the increased design space also leads to increased problems with bounding the design space for mass manufacturing, since the static timing analysis (STA) used for digital implementations is no longer sufficient.

Further, a digitally enhanced analog-mixed signal design may be used for the SNN. By augmenting the mixed signal designs with digital logic, an optimal bifurcation can be achieved in the performance versus energy usage versus chip area trade-off.

### Variability in an SNN

All circuit implementations, such as complementary metal-oxide-semiconductor (CMOS) circuits, suffer from variability in their physical structure and variability over time. Based on the design techniques used, there are different implications and solutions to make the designs work reliably. Within the context of this disclosure, these techniques are grouped together under the umbrella of calibration.

SNN IC designs suffer from unintended variabilities from the level of a complete IC to the individual transistor level, due to the effects of the technology, lithography, electrical, thermal and physical effects. The technology effects are related to process corners at the IC level, density variations at the level of the SNN array, and well-proximity and stress related at transistor level. Similarly lithography can affect the IC due to line width variations and the transistors due to proximity effects. Circuit imperfections may result in leakage current and device mismatch. Electrical effects such as supply voltage variability at IC level, substrate noise affects on the arrays, and jitter/crosstalk effects at the transistor level. Thermal effects can cause local and global gradients leading to dimensional variability. At transistor level thermal effects also add thermal noise. Physical effects can also lead to gradients which can have different global and local variabilities.

The local and global dimensional variability can in turn lead to temporal variability. These effects can vary from pico-second to long timescales such as days and years. The smaller timescale effects are due to effects such as electrical supply noise, substrate noise and thermal kT noise. Longer time scales effects in the range of micro to milli-seconds are due to temperature gradients and flicker noise. Further longer term effects in the range of seconds to minutes are due to supply noise, drift and flicker noise. Effects due to process, lithography and manufacturing issues are generally static over time.

A drawback of using analog-mixed signal circuits to implement SNN components is that the transfer functions of analog circuits can vary through the above-described process, voltage and temperature (PVT) variations. This means that a single SNN design may not be reproducible, as subsequent copies of the same circuit will have different values for properties such as gain, bandwidth, offset and amplitude. Furthermore, even a single copy may have unstable performance when its supply voltage is unstable or the ambient temperature changes. Therefore, a calibration methodology is needed to ensure that each copy of a specific analog SNN implementation performs the same way, regardless of any tolerances in manufacturing or variations in supply voltage or temperature.

Circuit parameters that are typically sensitive to PVT variations include gain, bandwidth, capacitance and resistance. Leakage currents in devices that are not meant to be conducting current, and mismatch between devices that are supposed to be equal are further examples of PVT effects on analog circuits.

In this disclosure these unintended variations due to the factors discussed above and other unintended variations in the operation of the SNN, are collectively referred to simply as “variation” or “PVT variation” unless otherwise indicated.

### Calibration Methods

Calibration of digital SNN's can be performed using static timing analysis (STA). This takes into account the spatial and temporal issues by creation of hierarchical models which are used together with timing models to bound the error in different paths of the circuits. The error bounded within a limit in both space and time ensures performance metrics such as frequency of operation are met. Further analysis such as IR drop analysis, post-layout simulation and parasitic extraction may be done for both digital and mixed signal designs. These ensure that variability in the supply voltage is within the design metrics. Mixed signal and analog heavy designs such as ADCs, DACs, PLLs etc. are typically calibrated using known calibration methods for each of the components.

However, for SNN designs comprising multiple analog, mixed signal and digital blocks which are connected to one another in complex connectivities which are use case dependent, the calibration problem is more difficult. Although there are known methodologies for calibrating the individual blocks used in such an SNN design, the present disclosure provides a means for calibration of a complete SNN SoC with different building blocks, with different connectivities, where observability of the internal nodes is limited, and/or with limited constrained measurement capabilities for the observables.

Observability at the internal nodes comes at a cost of increase in area of the IC, which increases cost. Extra observability can also cause limitations in the actual functionality. The present disclosure seeks to provide a way to calibrate an entire SNN SoC with minimal observability and measurement which can still reliably calibrate the entire system.

### Defining Bounds for the Variability

A bottom up approach can be used to bound the process variability at the level of a single component. How much variation can be expected can be determined from information supplied by the device manufacturer. Semiconductor device models typically include information specifying how much variation is expected between manufacturing runs, how much variation is expected between devices manufactured in the same run, and the variation of each parameter as a function of temperature. Circuit-level simulations can be performed to determine the effect of device parameters on network parameters. The result of such an analysis will be a table that describes the expected variation for each network parameter. As an example, it might specify that synapse weights, where the variability is largely determined by transistor mismatch, can vary by +/−15% for each synapse, that neuron thresholds can vary by +/−10 mV between manufacturing runs due to resistor inaccuracies, or that the amplitude of spikes generated by an input processing circuit varies by +/−30% across a temperature range of −50° C. to 150° C. due to transistor transconductance variation.

A top down approach may be used to bound the error due to variability from the use case for the SNN. How much variation in network parameters is allowable is different for each application. Some network architectures are highly sensitive to variations in synapse weights, while others are more sensitive to variations in neuron thresholds. Statistical simulations can be used to determine the level of sensitivity to each network parameter for a specific SNN implementation. The result of such an analysis will be a table that describes the allowed variation for each network parameter. As an example, it could specify that synapse weights should be accurate to within 2%, the neuron thresholds should match each other within 5%, and that the amplitude of spikes generated by the input processing circuit should always be 100 nA+/−10 nA. These results determine the resolution needed in the adjustment circuits implemented inside the network components: sufficient resolution should be available to adjust each circuit parameter to within its allowed tolerance. Similarly, the adjustment circuits' range should be large enough to counteract the amount of variation expected from circuit-level simulations.

### Observable Points in the SNN

The observable points within the SNN are defined, i.e. the points within the circuits at which a measurement can be made. Ideally as few observable points as possible should be used. They add to the IC area, make design functionally more challenging, and also increase power consumption. The observable points in principle can be the input, internal nodes and outputs of each of the building blocks of the SNN design at the SoC level. Some examples of observable points are the following:
A. Output of the neurons. The frequency of the spike train generated by each neuron may be measured. This observation point is relatively simple to observe since the neuron outputs are essentially digital.
B. Membrane potential of the neurons. The neuron membrane potential is harder to observe without causing functionality changes since the potential is linked to the integration time constants in the neuron.
C. Input signals (voltage/current) to the neurons. The neuron input signals can be observed depending on the connectivity of the synapse computation arrays. Since computational arrays typically have complex connectivities, this creates a practical upper bound on the number of observable points that can be made in an SNN design.
D. Output of each synapse individually. The outputs of the synapses form complex connected array structures like crossbars and trees. Each of the individual synapses can theoretically be observed, but since there are usually a large number of synapses in a complex routing network, observable points for individual synapses are hard to achieve.
E. Internal nodes of the synapses. Internal nodes of synapses are harder to observe since they are also part of complex connectivities.
F. Output of the input processing circuits. This can be observed for networks where they do not form part of the complex connectivities of the computational arrays. In many use cases they are distributed in the crossbar or tree-like connectivities within the array of synapses, which results in limitations on observing them from a routing perspective.
G. Input of the input processing circuits. This can be observed for networks where the inputs do not form part of the complex connectivities.
H. Encoder internal nodes. Depending on the complexity of the encoder, internal nodes of the encoder might need calibration.

Ideally as few as possible measurement circuits should be used since they come at the cost of increased IC area and power consumption of the SNN SoC. Frequency measurements may be made using known oscillator, counter circuits etc. Voltage and current measurements may use an analog-to-digital converter (ADC) to convert analog values to digital values for simpler measurement. The more frequently these measurements are made (whether a digital signal frequency or real time voltage or current measurements), the greater is the IC area and power hit for the system.

A trade-off can be made between number of observability points and measurement circuits versus accuracy of the calibration and the resulting SNN performance. This trade-off may be evaluated by defining cost functions for the calibration optimization problem, which may take into account the chip area used for the calibration and measurement circuits, the performance hit from additional observability points, power consumed by the calibration observability circuits during non-calibration time, power consumed by the calibration and measurement circuits, and routing complexity. The relative importance of the different cost functions should also be considered.

The design of each subcomponent has a performance versus area and performance versus power consumption trade-off, and the SNN use case should be considered in a network performance versus subcomponent performance trade-off.

The occasions when calibration is performed also needs to be considered. If any calibration steps need to be performed while the SNN is in operation, they should be performed in such a way that the SNN's operations are not disturbed. One way of doing this is to temporarily buffer any incoming signals to ensure the SNN is temporarily not processing any data, then use this time window to perform one or more calibration steps.

Another method to calibrate the SNN without disturbing its normal operation is to make use of redundancy in a crossbar architecture. For this purpose, the SNN neurosynaptic array may be designed to be slightly larger than the largest SNN design expected to be programmed inside, so that there is always at least one neurosynaptic column that remains unused. This spare column can then be calibrated independently of the rest of the chip. Once that is done, the configurable interconnect is modified such that the spare column is placed inside the active network, while the column that used to be in that position is disconnected and calibrated. A convenient moment to perform this action is at the moment the column's neuron generates an output signal, since the neuron's state is reset at this moment and the network's state will not change if a different column is inserted in place of an active column in the network.

On-line calibration can be performed at regular intervals, or can be performed only when the environmental conditions change. The supply voltage in a typical battery-powered system changes slowly as the battery is discharged or recharged, with timescales in the order of minutes or hours. Quick glitches on the supply line can be filtered out using passive components like capacitors and inductors, as well as by the self-regulating action of voltage regulator circuits. Most systems are also reasonably stable in temperature, with timescales typically in the order of tens of seconds or minutes. Supervisory circuits accompanying the SNN can be used to measure the supply voltage and temperature while the SNN is active and only trigger a calibration round when the environmental conditions change by a predetermined amount.

Calibration is needed in different timelines of a mass manufactured die. For example, calibration may be performed during bootup, periodically to cancel long term drift, based temperature measurement to cancel temperature effects, based on supply voltage measurement to compensate for supply variation effects, etc. When designing a calibration process, the time spent on calibration and the amount of calibration data needed to be stored versus use case performance should be considered. Cost functions may be used to evaluate area overhead for redundancy in the process, and power and time overhead for calibration during bootup, calibration to cancel long term drift, and calibration to cancel temperature effects.

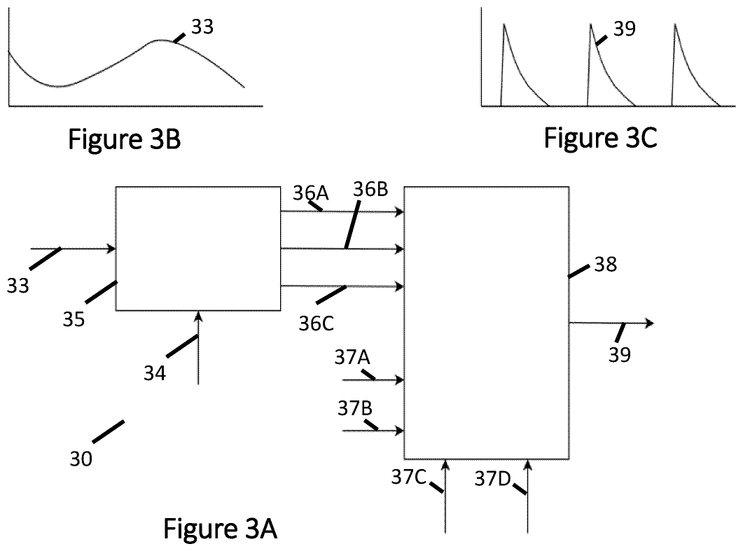

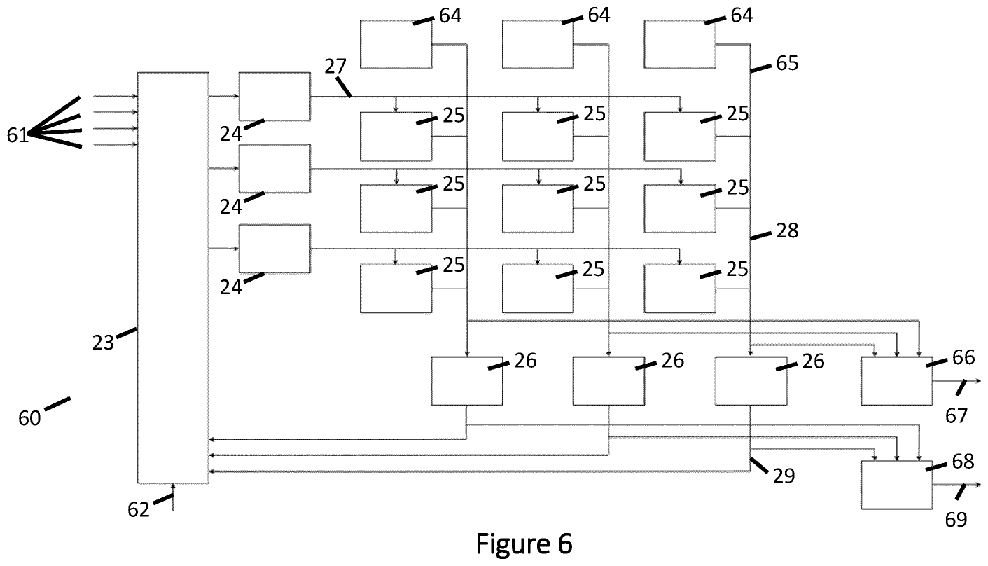

FIG. 3A is a simplified schematic diagram of an input shaping circuit 30 which may be used as an input processing circuit 23 in the SNN 20 of FIG. 2 and the SNN 60 of FIG. 6. The input shaping circuit 30 extracts useful information from the SNN input signal 33 and generates processed input signal 39, a spike train modulated with the extracted information. Depending on the application, useful information can be encoded in the input signal's amplitude, frequency, phase, duty cycle, digital code, or any other property of the signal.

As an example, an input shaping circuit 30 that modulates its output frequency fₒᵤₜ with the frequency of its input signal fᵢₙ would have a transfer function given by fₒᵤₜ=fᵢₙ·n+f_{carrier}, in which f_{carrier} is the carrier frequency and n is a constant. If the circuit modulates its output amplitude Aₒᵤₜ with the amplitude of its input signal Aᵢₙ, then its transfer function would be given by Aₒᵤₜ=Aᵢₙ·n, in which n is a constant.

The example input shaping circuit 30 shown in FIG. 3A includes an information extraction circuit 35 and pulse generation circuit 38. The information extraction circuit 35 receives an SNN input signal 33 and sends amplitude 36A, frequency 36B and number of pulses 36C outputs to pulse generation circuit 38, which generates a processed input signal 39 comprising a spike train. FIG. 3B shows a graph of an example SNN input signal 33 and FIG. 3C shows a graph of an example processed input signal 39 (showing variation in amplitude plotted against time on the horizontal axis).

Circuit non-idealities may affect the input shaping circuit 30 in many different ways, such as gain errors affecting the amplitude, delay errors affecting the phase, or local reference errors affecting processing of a digital input code. Compensation circuitry may be implemented to counteract the effects of circuit non-idealities, by adding such features as an adjustable input 34 to adjust gain, frequency or phase, circuit delay, or adjust a local reference.

Similarly, the pulse generation circuit 38 will have non-idealities causing errors in the output spike train amplitude, decay time, or inter-spike timing properties such as frequency, phase or density. The spike generation circuit 38 may be equipped with compensation circuits that can modify the parameters that are the most sensitive to variation and that are relevant to the intended signal processing function, using adjustment inputs such as rise time 37A and decay time 37B, amplitude 37C and timing 37D adjustment signals.

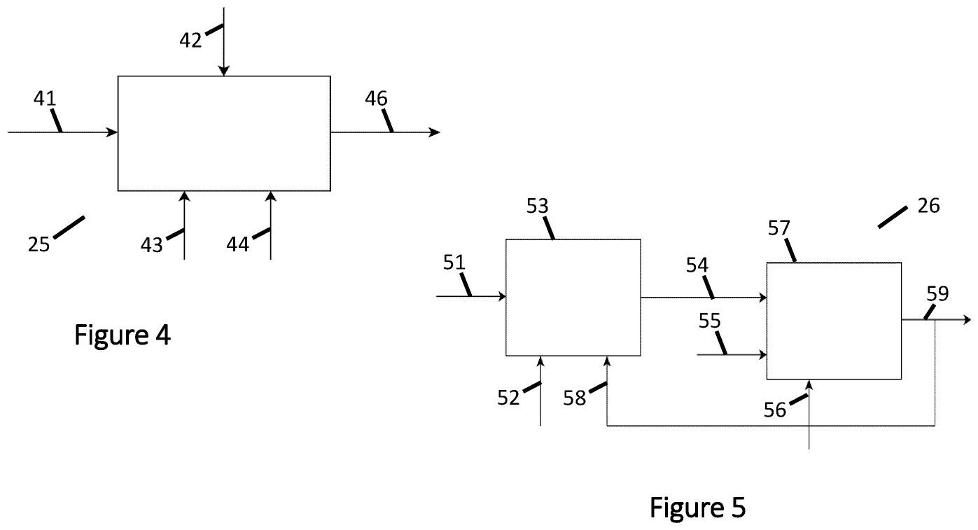

FIG. 4 is a simplified schematic diagram of a synapse 25 which may be used in the SNN of FIG. 2 and the SNN 60 of FIG. 6. Synapse 25 receives a processed input signal 41 (from an input processing circuit 24) and applies a weight 42 (e.g. multiplying the input signal 41 and weight 42) to generate a synapse output signal 46.

The synapse's transfer function is nominally given by Iₒᵤₜ=Iᵢₙ19 (w/wₘₐₓ), in which Iₒᵤₜ is the output current, Iᵢₙ is the input current, w is the weight programmed into the synapse and wₘₐₓ is the maximum possible weight value. Circuit non-idealities will cause additive and multiplicative errors such that the transfer function becomes Iₒᵤₜ=α·Iᵢₙ·(w/wₘₐₓ)+β, in which α is a multiplicative error and β is an offset error. Adjustment circuits may be added to the synapse 26 to counteract these non-idealities, by implementing an adjustable gain factor input 43 that can counteract α and an adjustable offset input 44 that can counteract β. An adjustment to the weight 42 may also be used to adjust the synapse 25.

FIG. 5 is a simplified schematic diagram of a neuron 26 which may be used in the SNN of FIG. 2 and the SNN 60 of FIG. 6. In this example, the neuron 26 includes an integrator circuit 53 and comparator circuit 57. The integrator circuit 53 receives one or more synapse output signals as an input 51, integrates (accumulates) this input, and sends a resulting membrane potential signal 54 to comparator circuit 57. The comparator circuit 57 compares the received membrane potential 54 with a reference potential 55 which operates as a spike threshold. The comparator circuit 57 generates a spike as a neuron output signal 59 when the membrane potential exceeds the spike threshold. The spike also operates as a reset signal 58 to reset the integrator circuit 53.

A typical implementation of an electronic neuron 26 might use a capacitor as the integrating element 53. When manufactured on an integrated circuit, a capacitor's value may typically vary by around 20% between manufacturing runs. In addition, multiple copies of nominally identical capacitors on a single chip may vary among each other by around 5%. Furthermore, the capacitance may have a temperature coefficient which, depending on the dielectric material used to manufacture the capacitor, might add several percent's worth of variation across a typical commercial or industrial temperature range. All of these variations cause the integration constant of the neuron 26 to be poorly defined, which will cause uncertainty in the SNN's signal processing function.

The neuron integrates its input signal 51 and generates a neuron output signal 59 when the integrated value reaches a spike threshold. The output spiking frequency of a neuron can be described by fₒᵤₜ=g/(C·V)∫iᵢₙ dt, in which g is the input's gain, C is the capacitance, V is the threshold voltage and iᵢₙ is the input current. Circuit non-idealities can affect the gain g, the slope of the integrator defined by C, or the spike threshold value V. Adjustment circuits may be added to the neuron 26 to counteract the effect of each of these non-idealities. Since the gain and slope of the integrator both affect the neuron's transfer function as a multiplicative error, both can be compensated simultaneously by adding an adjustable gain input 52 to the integrator 53. Errors in the spike threshold value can be compensated by adding a reference potential offset value 55 and/or an adjustable spike threshold 56 to the comparator 57.

FIG. 6 is a simplified schematic diagram of an SNN 60, comprising the SNN 20 of FIG. 2 and also including offset current generators 64 and an analog-to-digital converter 66 for use in calibration of the SNN. Other features of the SNN 20 of FIG. 2 may also apply for the SNN 60 of FIG. 6. Similarly to the embodiment in FIG. 2, each row of synapses 25 receives a processed input signal 27 from one input processing circuit 24. Each synapse 25 applies a weight to the received processed input signal 27 and generates a synapse output signal 28.

The array is expanded with the addition of a row of offset current generators 64, one for each synapse 25 in a row of synapses. Each offset current generator (OCG) 64 generates an offset current 65. One OCG 64 and multiple synapses 25 for each column of the array. The offset current 65 from one of the OCGs 64 and the synapse output signals 28 from a column of synapses 25 is received by one of the neurons 26. Each neuron 26 integrates the received synapse output signals 28 and generates a neuron output signal 29 when the integrated value reaches a predetermined threshold, so that the neuron output signal 29 takes the form of a spike train.

The OCGs 64 can be seen as an additional row of synapses that add constant signals instead of spike trains to each neurosynaptic column. Each OCG 64 generates a constant offset current output 65 controlled by their input code. The ideal transfer function of the OCG 64 is represented as Iₒᵤₜ=I_{ref}·(code/codeₘₐₓ). However, circuit non-idealities may add error terms and factors, changing the transfer function to becomes Iₒᵤₜ=α·I_{ref}·(code/codeₘₐₓ)+β. To address these non-idealities, the circuit may be provided with an adjustment mechanism that adds an adjustable gain and offset which is sufficient to counteract the effects of the gain error α and the offset error β.

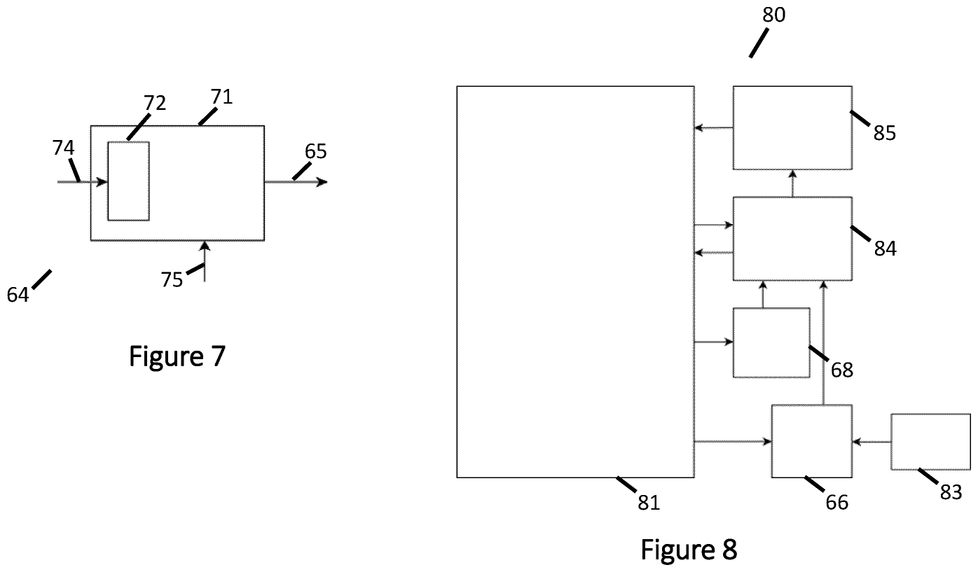

FIG. 7 shows an example of an offset current generator 64 comprising a DC current source 71 and having a gain adjustment implemented by adding an additional gain stage 72, such as an analog amplifier or a scaled current mirror, which has an externally adjustable gain input 74. An offset adjustment 75 can be implemented by an adjustable constant signal source whose output is added to the offset current source output 65. The OCGs 64 may be used to provide a bias current to the neurosynaptic array (i.e. the synapses 25 and neurons 26) during operation, and may also be used to assist in calibration as explained below. The OCGs 64 are preferably included in the same IC as the neurosynaptic array of SNN 60, but they may alternatively be implemented separately and connected to the neurosynaptic array when required.

Referring back to FIG. 6, the SNN 60 also includes an analog-to-digital converter (ADC) 66 that can be connected to the output of any of the neurosynaptic columns, each column including an OCG 64 and multiple synapses 25. The ADC 66 is connectable (e.g. via switched connections or a multiplexer or circuits within the ADC which select an input) to receive the analog signals generated by one of the neurosynaptic columns, i.e. i.e. the combined signals from the OCG 64 and multiple synapses 25 in a column of the array of synapses. The ADC 66 converts the received analog signals to a digital signal 67 for measurement in the digital domain. The ADC 66 is preferably included in the same IC as the neurosynaptic array of SNN 60, but it may alternatively be implemented separately and connected to the neurosynaptic array when required. Instead of having a single ADC 66 which is switchable to receive an input from different sets (columns) of the synapses 25 and OCG 64, the SNN 60 may alternatively be provided with multiple ADCs which may operate in parallel, each receiving an input from a different set of the synapses and OCG. Multiple ADCs result in a more complex and costly implementation, but the calibration measurements may be performed in parallel and thus faster.

The SNN 60 may also include components for measuring the frequency of the neuron output signal 29 from each neuron 26, i.e. measuring the frequency of spikes produced by the neuron 26. The embodiment in FIG. 6 includes a frequency measurement circuit 68, which is connectable (e.g. via switched connections or a multiplexer or other circuits within the frequency measurement circuit 68 which select an input) to receive a neuron output signal 29 from the neurons 26. The frequency measurement circuit 68 generates an output 69 which indicates the frequency of the spike train produced the neuron 26 being measured. The neuron output frequency may be measured by comparing the neuron output signal 29 to a reference clock using a counter or other circuit.

FIG. 8 is a simplified schematic diagram of an overall structure of an SNN with an analog or mixed signal SNN 81, analog-to-digital converter 66 with external reference 83, a frequency measurement circuit 68, a processing element 84, and memory 85. These components may all be implemented on the same IC or SoC, or may be implemented in one or more separate ICs.

The SNN 81 of FIG. 8 may have the same structure and details as the SNN 60 of the FIG. 6 embodiment (except that the ADC 66 and frequency measuring circuit 68 are shown separately in FIG. 8). The ADC 66 is connectable for receiving analog signals as an input from the SNN 81 (in the same manner as described above for FIG. 6) and converting them to a digital signal using external reference signal 83. The digital signal output from ADC 66 is received by processor 84, which runs software or firmware to perform a calibration procedure and store results in the memory 85. More than one ADC 66 may be used to speed up the calibration procedure, as mentioned previously.

The frequency measurement circuit 68 is connectable for receiving neuron output signals as an input from the SNN 81 (in the same manner as described above for FIG. 6) and generating an output based on the input frequency. The output from frequency measurement circuit 68 is also received by processor 84. More than one frequency measurement circuit 68 may be used to speed up the calibration procedure. Alternatively, the frequency measurement may be performed directly by the processor 84, which receives the neuron output signals 29 directly from the SNN 81.

The processor 84 may be implemented as a microprocessor executing software, a field programmable gate array (FPGA), an application specific circuit (ASIC), or other type of processing element suitable for executing the calibration procedures described herein. A single processor may be used to execute the calibration procedures or multiple processors may be used and the calibration procedures divided among them.

The calibration procedures comprise several stages in which relevant parameters are measured through the ADC 66 and network parameters are adjusted to counteract PVT variations. The network elements (e.g. input processing circuits 24, synapses 25, neurons 26, and OCGs 64) may have adjustment mechanisms as described herein that can be used to modify their relevant parameters to correct for variations in the elements. These adjustments will typically be controlled through a digital interface. The value of the adjustments to be applied will then be stored in a digital memory 85. Other methods are possible however, such as laser trimming in which a small incision is made in on-chip devices, or analog trimming in which a voltage is stored onto a well-insulated capacitor.

The calibration procedures as described can be modified to account for differences in sensitivity to manufacturing variation and environmental factors, depending on the circuits in question. As an example, if the design of the neurons is based around current mirror-type circuits, then only a single calibration step is needed before the neuron is ready for use. If the neuron is based on circuits depending on the transconductance of a transistor, then it will require calibration during operation. For each network component type, and therefore for each step of the calibration procedure, a decision should be made to include it in the initial before-use calibration step, to include it in the online calibration procedure, or both.

The various steps of the calibration procedures all have a certain cost in terms of chip area, power consumption, time and memory requirements. These costs need to be taken into account when designing the various SNN components. For each component a trade-off analysis needs to be performed to balance the costs incurred against the gains achieved.

As an example, adding adjustment features to the synapses will incur a significant chip area penalty on the entire neurosynaptic array, since synapses will typically account for the majority of the chip's area. Implementing a gain and offset adjustment feature on each single synapse might become impractical from a wiring standpoint as well, leading to the decision to reduce the number of adjustment bits to the absolute minimum, or even abolish this feature altogether in favour of only measuring the non-ideal behaviour of each synapse and taking it into account when programming the weights. For example, if one specific synapse turns out to have a gain error of −10%, this can be counteracted by increasing the weight value programmed into it by 10%.

Another example of a trade-off in adjustment circuit design is in the threshold value of the neuron. In many cases this will be a fixed voltage, which is ultimately derived from an on-chip voltage reference such as a bandgap reference circuit. Making such a voltage adjustable for each neuron may require implementing a digital-to-analog converter (DAC) for each single neuron. A high-resolution DAC will typically require a large chip area and large bias currents to counteract the effects of mismatch and noise. The number of DAC bits implemented, and therefore the amount of chip area and power consumption added, should be weighed against the expected gain in signal processing accuracy due to the additional threshold voltage accuracy.

By contrast, making an on-chip ADC adjustable to a high degree of accuracy can be worthwhile when there is only one ADC and thus any chip area penalty is not incurred multiple times across the chip. In addition, because the ADC is only used during calibration and can be turned off afterwards, the ADC can have comparatively relaxed requirements on power consumption.

When the effects of PVT variations on all circuits in a large array add up, the overall transfer function of the network will be impossible to control accurately. A modified crossbar circuit with calibration elements is therefore proposed, along with a procedure that aims to ensure that the relevant parameters of each network element are controlled to a predetermined level of accuracy.

The overall procedure to calibrate an analog or mixed-signal SNN depends on the exact configuration of the network. As an example, the following calibration procedures are described for the network structure as shown in FIG. 6 and FIG. 8. The calibration procedure starts with calibrating the ADC 66 using an external well-characterized signal source 83. Once the ADC's input-to-output transfer function is well characterized in this way, it can be stored and used to calibrate the components of the SNN 60/81.

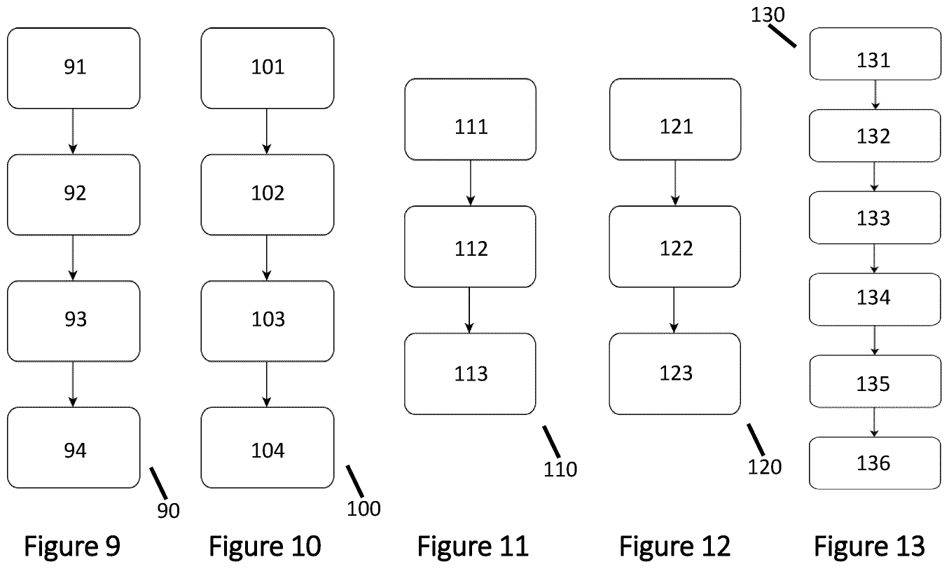

FIG. 9 is a flowchart showing steps of the ADC calibration procedure 90. In step 91 the external reference 83 is connected to ADC 66, which converts the received external reference 83 to a digital output. In step 92, ADC 66 is adjusted so that the digital output is correct, and in step 93 the external reference 83 is disconnected. In step 94 the ADC 66 is used to calibrate the SNN 81 as described below.

FIG. 10 is a flowchart showing the high-level stages of the calibration procedure for the SNN. First the OCGs 64 are calibrated (step 101). The neurons 26 are then calibrated (step 102) preferably making use of the previous calibration of the OCGs 64 (i.e. using the previously determined transfer functions of the OCGs 64 or using the OCGs 64 adjusted to reduce PVT variations). Then the input processing circuits 24 (step 103) and the synapses 25 (step 104) are calibrated, preferably making use of the previous calibration OCGs 64 and neurons 26 (i.e. using the previously determined transfer functions of the OCGs 64 and neurons 26 or using the OCGs 64 and/or neurons 26 which have adjusted to reduce PVT variations).

As explained below, the calibration in each stage involves measuring a transfer function of the relevant elements of the SNN and may also involve adjustment of the elements to correct or reduce the PVT variations in the elements if they are provided with facilities for individual adjustment. As explained previously, the trade-off between reduced PVT variations and greater accuracy versus increased chip area and power consumption may dictate that some elements of the SNN have limited or no facilities for individual adjustment.

FIG. 11 is a flowchart of a procedure for calibrating the OCGs 64 of the SNN 81. In step 111, the OCGs 64 are set to output an offset current signal 65 equal to a predetermined reference output current for the calibration procedure. The ADC 66 is connected to receive an offset current signal 65 from each OCG 64 in turn and convert the received analog signal 65 to a digital signal. Because of PVT variations, these offset current signals 65 will be different from the nominal value the OCGs were designed to produce. The digital signals produced by ADC 66 are received by processor 84, which may calculate a transfer function of each OCG 64 and determine adjustment signals, such as a gain adjustment signal 74 and an offset adjustment signal 75, to correct for any PVT variations in the relevant OCG 64.

After these measurements, the OCGs 64 can be adjusted to bring their value as close to the nominal value as required. The ultimate limit to the accuracy of the offset current signals 65 produced by the OCGs 64 is the accuracy and resolution of the ADC 66, and the range and resolution of the adjustment mechanism of the OCGs 64. The transfer functions and/or the adjustment signals may be stored in data storage memory 85.

An additional benefit of calibrating the OCGs in this way is that this step will simultaneously cancel out any leakage current flowing in the synaptic column. Although the synapses 25 will not be active and may be turned off during this step, and thus they should not be conducting any current, the synapses will in practice draw a leakage current. Since this leakage current is indistinguishable from any signal currents, it should be cancelled to avoid that it interferes with normal operation of the SNN 60. Since the leaking synapses 25 are connected to the OCG 64 and the ADC 66 during the OCG calibration step, any leakage current present in the column is measured by the ADC 66 and compensated when the OCG is adjusted.

FIG. 12 is a flowchart of a procedure for calibrating the neurons 26 of the SNN 81. Once the offset current signals 65 generated by the OCGs 64 are well characterized, they can be used as reference inputs for calibrating the neurons 26. In step 121, the (previously calibrated) OCGs 64 are set to output offset currents 65 having a predetermined value suitable for the neuron calibration procedure. In step 122, the output frequency of the neurons 26 (i.e. the frequency of the spikes generated by the neurons) is measured by frequency measurement circuit 68. The neuron output frequency can usually be measured accurately, since digital systems typically contain an accurate clock which may be used for the measurement. By measuring each neuron's output frequency as a response to a known input signal (i.e. the calibrated offset current signal 65), the transfer function of each of the neurons 26 can be accurately determined by the processor 84.

In step 123, the measured neuron output frequency is received by the processor 84 for each neuron 26, and any deviation from the expected value may be detected, so that deviations in the transfer function of the neurons 26 resulting from PVT variations can be determined. If the neurons 26 are provided with an adjustment mechanism, such as an input gain adjustment 52, a reference potential offset value 55, and/or a spike threshold adjustment 56, the processor 84 may calculate these adjustments and adjust the individual neurons to account for these PVT variations. The transfer functions of the neurons 26 and/or the adjustment signals for the neurons may be stored in data storage memory 85.

FIG. 13 is a flowchart of a procedure for calibrating the input processing circuits 24 and synapses 25 of the SNN 81. Once the OCGs 64 and the neurons 26 are characterized, e.g. by using the above-described calibration procedures, this information can be used for calibration of the synapses 25 and input processing circuits 24.

In step 131, a predetermined input signal 61 (such as a spike train with known amplitude and frequency) is applied to one of the input processing circuits 24 and in step 132 the weights of the synapses 25 are set to a predetermined value. In step 133 the frequencies of the neuron output signals 29 generated by the neurons 26 are measured by the frequency measurement circuit 68 and these measured values are received by processor 84.

Since both the input signal 61 and the input-to-output transfer function of each neuron 26 is known, the combined transfer function of the input processing circuit 24 and synapse 25 through which the input signal flows to each neuron 26 can be determined by processor 84. This transfer function can then be corrected by adjusting the relevant input processing circuit 24, the relevant synapse 25, or both.

Since both the input processing circuit 24 and the synapse 25 will be affected by PVT variations, both will contribute to the inaccuracy measured in step 133. The two contributions can be separated by measuring the average synapse output signal across a row of synapses 25 connected to a single processing circuit 24. The PVT variations contributed by the synapses 25 will be substantially averaged out of the measured row signal, leaving only the PVT variation contributed by the input processing circuit 24.

The synapse output signals from the row of synapses 25 will be received by the row of neurons 26. The output frequencies of these neurons are measured in step 133 and may be averaged to substantially isolate the PVT variation contributed by the relevant input processing circuit 24. In step 134, the input processing circuit 24 may be adjusted, e.g. by adjusting an input gain 34, rise time 37A, decay time 37B, amplitude 37C, and/or timing 37D to bring the transfer function within the desired tolerance.

In step 135, after adjustment of the input processing circuit 24, the measured neuron output frequency for one of the neurons 26 may be used by processor 84 to determine the transfer function of the relevant synapse 25 (i.e. the synapse 25 through which the input signal flowed from the input processing circuit 24 to the measured neuron 26). In step 136, the transfer function of the relevant synapse 25 may be used to adjust the synapse 25, e.g. using a gain adjustment signal 43 and/or an offset adjustment signal 44, if the synapse has these facilities, or by adjusting the weight 42. The transfer functions of the input processing circuit 24 and synapse 25 and/or the adjustment signals for the input processing circuit 24 and/or the synapse 25 may be stored in data storage memory 85.

An alternative for the calibration procedure of FIG. 13 is that, instead of measuring frequency of neuron output signals 29 in steps 133 and 135, the output voltage or current of the relevant synapses 25 are routed to ADC 66 and measured by the ADC in the same manner as used in the OCG calibration procedure. This enables the transfer function of the input processing circuit 24 and synapse 25 to be measured directly by the ADC 66, rather than using the neurons 26 to produce spike trains which are then measured by the frequency measurement circuit 68. When using this alternative, the predetermined input signal 61 applied to the input processing circuit 64 may be a constant signal rather than a spike train.

The calibration procedures described above can be modified to suit many other network architectures. As an example, another network topology can be designed in which there are encoders in place of the input shaping circuits. Such a topology would enable sensors to be directly connected to the SNN, without any intermediate signal processing. Calibrating such a topology would follow a similar pattern as that just described, but with the input processing circuit calibration procedure used to calibrate the encoders. The contents of this step depend on the signal transfer function of the encoder and its specific sensitivity to process and temperature variation.

In the case of an encoder that generates a spike train with a frequency proportional to the amplitude of the input signal voltage, the encoder calibration step could consist of applying a well-defined static input signal to the encoder and measuring the resulting frequency of the current flowing in the synaptic column. The voltage-to-frequency transfer of the encoder can then be adjusted until it matches a predetermined value.

It is important however to take all possible non-ideal behaviours into account. For example, the encoder might suffer from DC leakage currents whenever no signals are being processed. In that case, the encoders' leakage needs to be taken into account during the offset calibration step to ensure the leakage does not disturb any subsequent calibration steps.

The calibration procedures cannot distinguish between variation caused by tolerances in the manufacturing process, which is fixed for each individual copy of the circuit, and variation caused by changes in supply voltage and temperature, which vary during the lifetime of the circuit. The calibration procedure will therefore need to be performed at least once to compensate for manufacturing variation, and performed again, whether completely or partially, when environmental factors change.

Inaccuracies in manufacturing typically lead to variations in circuit performance that remain constant during the lifetime of the product. A typical example is offset in matched pairs of CMOS transistors, as commonly used in sub-circuits like current mirrors. Although the designer intends to have two transistors that are exactly equal, tolerances in manufacturing will cause the two transistors to be slightly different. Common causes of such mismatch are roughness of the lines drawn on the chip, random scattering of implanted atoms, and variations in the thickness of oxide layers grown on the wafer.

In a current mirror designed to exactly copy an incoming current to its output, the expected transfer function is Iₒᵤₜ=Iᵢₙ. Manufacturing tolerances will cause this to change to Iₒᵤₜ=n*Iᵢₙ, where n is a number unequal to one determined by the specific manufacturing inaccuracies present in an individual copy of the circuit. Since the physical effects affecting this factor are fixed and do not change, a single calibration step directly after the circuit is manufactured will be enough to bring n close to unity for the lifetime of the circuit.

Other circuit parameters are sensitive to environmental factors like supply voltage and temperature. An example is the transconductance of a CMOS transistor, which is determined by the gate-source voltage, the drain-source voltage, the physical characteristics of the device, and the temperature. Since any of these parameters apart from the physical characteristics are liable to change at any moment when the transistor is in use, it is not possible to compensate for any variations up front. Any calibration required will need to be performed while the device is in operation.

Depending on the expected variability of each parameter and the effect each parameter has on the overall performance of the chip, certain steps are performed at different moments in the chip's lifecycle. An initial test procedure, typically called “wafer sort”, is performed at the end of a wafer manufacturing process, in which the essential functionality of each chip is tested. Any chips for which it is determined that the variation of a critical parameter is larger than the range of its associated adjustment mechanism are discarded at this point. The remaining chips are then packaged and re-measured in a final test step. This step will include an initial calibration step that aims to counteract as much as possible all manufacturing variation in circuit parameters that are expected to stay constant across the lifetime of the chip. The resulting values are stored in a memory that could either be incorporated into the same chip package, or it could be stored externally but still associated with the individual chip on which it was measured through administrative means such as serial number tracking.

The invention thus discloses systems and methods for calibration of an SNN.

Note that features of any of the embodiments disclosed herein may be combined in an appropriate manner.

1. A spiking neural network comprising:
a plurality of input processing circuits, each input processing circuit having an input for receiving a spiking neural network input signal and being configured to apply a transfer function to the input signal to generate a processed input signal;
a plurality of offset current generators, each offset current generator configured to generate an offset current signal at a predetermined level;
a plurality of synapses, each synapse connected to receive a processed input signal from one of the input processing circuits and configured to apply a predetermined weight to the processed input signal to generate a synapse output signal;
a plurality of neurons, each neuron connected to receive synapse output signals from a subset of the synapses and an offset current signal from one of the offset current generators, and each neuron configured to generate a neuron output signal in response to the received synapse output signals and offset current signal; and
an analog-to-digital converter having an input, the input being connectable to receive an offset current signal from one of the offset current generators, and being configured to convert the received offset current signal to a corresponding digital output signal.

2. The spiking neural network of claim 1, wherein the offset current generators are each individually adjustable to adjust the offset current signal.

3. The spiking neural network of claim 2, further comprising a first processing circuit connected to receive the digital output signal generated by the analog-to-digital converter, and configured to generate an adjustment signal for adjusting a corresponding one of the offset current generators to produce an adjusted offset current signal.

4. The spiking neural network of claim 1, further comprising a frequency measurement circuit connected to receive a neuron output signal from one of the neurons, and generate an output indicating a frequency of the received neuron output signal.

5. The spiking neural network of claim 4, wherein the neurons are individually adjustable to adjust an input gain, a spike threshold, and/or a reference potential offset value of the neuron.

6. The spiking neural network of claim 5, further comprising a second processing circuit connected to receive the output from the frequency measurement circuit, and configured to generate an adjustment signal for adjusting a corresponding one of the neurons.

7. The spiking neural network of claim 1, wherein each of the synapses is adjustable to adjust an input gain and/or an offset value of the synapse.

8. The spiking neural network of claim 1, wherein each of the input processing circuits is adjustable to adjust an input gain, a spike threshold, and/or a timing value of the input processing circuit.

9. The spiking neural network of claim 1, wherein the analog-to-digital converter is connectable to receive a synapse output signal from one of the synapses, and is configured to convert the received synapse output signal to a corresponding digital synapse output signal.

10. The spiking neural network of claim 1, further configured to provide a calibration mode in which one or more of the spiking neural network input signals are set to predetermined values.

11. The spiking neural network of claim 10, further comprising a third processing circuit connected to receive a signal from a frequency measurement circuit indicating a frequency of a neuron output signal of one of the neurons during the calibration mode, the neuron connected to receive a synapse output signal from one of the synapses which is connected to receive a processed input signal from one of the input processing circuits, wherein the third processing circuit is configured to generate an adjustment signal for adjusting the input processing circuit and/or the synapse.

12. The spiking neural network of claim 9, further comprising a fourth processing circuit connected to receive the digital synapse output signal during the calibration mode, and configured to generate an adjustment signal for adjusting the input processing circuit and/or the synapse.

13. A method for calibrating a spiking neural network, the spiking neural network comprising a plurality of offset current generators configured to generate offset current signals, a plurality of input processing circuits configured to generate processed input signals, a plurality of synapses configured to apply a weight to the processed input signals to generate synapse output signals, and a plurality of neurons connected to receive one of the offset current signals and synapse output signals from a plurality of the synapses and configured to generate neuron output signals, the method comprising:
generating a plurality of offset current signals, each at a predetermined level, by the plurality of offset current generators; and
converting the offset current signals to corresponding digital output signals.

14. The method of claim 22, further comprising:
receiving the plurality of adjusted offset current signals in the plurality of neurons;
measuring a frequency of the neuron output signals; and
adjusting an input gain, a spike threshold, and/or a reference potential offset value of each of the neurons based on the adjusted offset current signal received by the respective neuron and the measured frequency of the neuron output signal generated by the respective neuron.

15. The method of claim 14, further comprising calculating a transfer function for the neurons, wherein the transfer function for each neuron is based on the adjusted offset current signal received by the neuron and the measured frequency of the neuron output signal of the neuron.

16. The method of claim 13, further comprising:
providing a spiking neural network input signal set to a predetermined value to a first one of the input processing circuits;
setting a weight of a first one of the synapses to a predetermined value;
receiving a processed input signal from the first input processing circuit by the first synapse, and generating a corresponding synapse output signal in response;
receiving the synapse output signal from the first synapse and an adjusted offset current signal from a first one of the offset current generators by a first one of the neurons;
measuring a frequency of the neuron output signal generated by the first neuron; and
adjusting the first input processing circuit and/or adjusting the first synapse to adjust a transfer function of the first input processing circuit and the first synapse based on the spiking neural network input signal and the measured neuron output signal frequency.

17. The method of claim 13, further comprising:
providing a spiking neural network input signal set to a predetermined value to a first one of the input processing circuits;
setting weights of a first subset of the synapses to predetermined values;
receiving a processed input signal from the first input processing circuit by the first subset of synapses, and generating a corresponding synapse output signal from each synapse of the first subset of synapses in response;
receiving the synapse output signals from the first subset of synapses by the neurons;
measuring a frequency of each neuron output signal generated by the neurons; and
adjusting the first input processing circuit to adjust a transfer function of the first input processing circuit based on the spiking neural network input signal and the measured frequencies of the neuron output signals.

18. The method of claim 17, further comprising:
providing a spiking neural network input signal set to a predetermined value to a first one of the input processing circuits;
receiving a processed input signal from the first input processing circuit by a first one of the first subset of synapses, and generating a corresponding synapse output signal in response;
receiving the synapse output signal from the first synapse of the first subset of synapses and an adjusted offset current signal from a first one of the offset current generators by a first one of the neurons;
measuring a frequency of the neuron output signal generated by the first neuron; and
adjusting the first synapse to adjust a transfer function of the first synapse based on the spiking neural network input signal and the measured neuron output signal frequency.

19. The method of claim 13, further comprising:
providing a spiking neural network input signal set to a predetermined value to a first one of the input processing circuits;
setting a synapse weight of a first one of the synapses to a predetermined value;
receiving a processed input signal from the first input processing circuit by the first synapse, and generating a corresponding synapse output signal in response;
converting the synapse output signal to a corresponding digital output signal; and
adjusting the first input processing circuit and/or adjusting the first synapse to adjust a transfer function of the first input processing circuit and the first synapse based on the spiking neural network input signal and the digital output signal.

20. The method of claim 13, further comprising:
providing a spiking neural network input signal set to a predetermined value to a first one of the input processing circuits;
setting weights of a first subset of the synapses to predetermined values;
receiving a processed input signal from the first input processing circuit by the first subset of synapses, and generating a corresponding synapse output signal from each synapse of the first subset of synapses in response;
converting the synapse output signals from the first subset of synapses to corresponding digital output signals; and
adjusting the first input processing circuit to adjust a transfer function of the first input processing circuit based on the spiking neural network input signal and the digital output signals.

21. The method of claim 20, further comprising:
providing a spiking neural network input signal set to a predetermined value to a first one of the input processing circuits;
receiving a processed input signal from the first input processing circuit by a first one of the first subset of synapses, and generating a corresponding synapse output signal in response;
converting the synapse output signal from the first synapse to a corresponding digital output signal; and
adjusting the first synapse to adjust a transfer function of the first synapse based on the spiking neural network input signal and the digital output signal.

22. The method of claim 13, further comprising:
adjusting the offset current generators based on the digital output signals to produce an adjusted offset current signal from each of the offset current generators.
